(19) United States
(12) Patent Application Publication
(10) Pub. No.: US 2026/0369749 A1
(43) Pub. Date: Nov. 19, 2026

(54) SECONDARY BATTERY, CASE FOR SECONDARY BATTERY AND METHOD FOR MANUFACTURING SECONDARY BATTERY

(71) Applicant: SAMSUNG SDI CO., LTD., Yongin-Si (KR)

(72) Inventors: Jeongsoo LIM, Yongin-Si (KR); Sunyang HONG, Yongin-Si (KR); Jong-Ha LEE, Yongin-Si (KR)

(21) Appl. No.: 19/573,535

(22) Filed: Mar. 20, 2026

(30) Foreign Application Priority Data
Mar. 27, 2025 (KR) 10-2025-0039351

(51) Int. Cl. H01M 50/103; H01M 10/04; H01M 50/119; H01M 50/15; H01M 50/159; H01M 50/176

(52) U.S. Cl. CPC H01M 50/103; H01M 10/049; H01M 50/119; H01M 50/15; H01M 50/159; H01M 50/176

(57) ABSTRACT

A case for a secondary battery includes: a body having an opening at one end, and including a receiving space to accommodate an electrode assembly; and a cover to be coupled to the one end having the opening to seal the receiving space. The body further includes a processed portion in at least one corner region of a surface of the body to be coupled with the cover.

### CROSS-REFERENCE TO RELATED APPLICATION

The present application claims priority to and the benefit of Korean Patent Application No. 10-2025-0039351, filed on Mar. 27, 2025, in the Korean Intellectual Property Office, the entire disclosure of which is incorporated by reference herein.

### BACKGROUND

### 1. Field

Aspects of embodiments of the present disclosure relate to a secondary battery, a case for a secondary battery, and a method for manufacturing a secondary battery.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the electrode assembly, and electrode terminals connected to the electrode assembly.

A case of a secondary battery used in small electronic devices mainly includes a metal material, such as an aluminum alloy, but the case may be damaged for complex reasons in various processes.

The above information disclosed in this Background section is for enhancement of understanding of the background of the present disclosure, and therefore, it may contain information that does not constitute related (or prior) art.

### SUMMARY

When performing a press/drawing process for forming a can that forms a case of a secondary battery, if a thickness deviation or variation occurs in a flange portion for welding between the can and a cover, the thickness deviation or variation may cause a welding defect.

Embodiments of the present disclosure may be directed to a secondary battery having an improved case, the case for the secondary battery, and a method for manufacturing the secondary battery.

However, the aspects and features of the present disclosure are not limited to those described above, and the above and additional aspects and features will be set forth, in part, in the description that follows, and in part, may be apparent from the description.

According to one or more embodiments of the present disclosure, a case for a secondary battery includes: a body having an opening at one end, and including a receiving space configured to accommodate an electrode assembly; and a cover configured to be coupled to the one end having the opening to seal the receiving space. The body further includes a processed portion in at least one corner region of a surface of the body to be coupled with the cover.

In an embodiment, the body may include a flange portion extending from the one end having the opening of the body to be coupled with the cover, the flange portion including the processed portion in the at least one corner region.

In an embodiment, the processed portion in the at least one corner region of the flange portion may be recessed inward toward the opening.

In an embodiment, the processed portion may be recessed inward toward the opening in a shape of one of a triangle, a rectangle, or an arc.

In an embodiment, the processed portion may be recessed inward toward the opening by a value greater than or equal to 50% and less than or equal to 95% of a width of the flange portion.

In an embodiment, the processed portion in the at least one corner region of the flange portion may be a through-hole spaced from the opening by a distance.

In an embodiment, in a plan view, the through-hole of the processed portion may have a shape of one of a triangle, a rectangle, or a circle.

In an embodiment, the distance by which one end of the through-hole of the processed portion is spaced from the opening may be 0.2 mm to 0.3 mm.

In an embodiment, the body and the cover may include a same metallic material as each other.

In an embodiment, the metallic material may include stainless use steel.

According to one or more embodiments of the present disclosure, a secondary battery includes: an electrode assembly including a first electrode, a separator, and a second electrode; a body having an opening at one end, and including a receiving space accommodating the electrode assembly; and a cover coupled to the one end having the opening, and sealing the receiving space. The body includes a processed portion in at least one corner region of a surface coupled with the cover.

In an embodiment, the body may include a flange portion extending from the one end having the opening of the body and coupled with the cover, the flange portion including the processed portion in the at least one corner region.

In an embodiment, the processed portion in the at least one corner region of the flange portion may be recessed inward toward the opening.

In an embodiment, the processed portion in the at least one corner region of the flange portion may be a through-hole spaced from the opening by a distance.

According to one or more embodiments of the present disclosure, a method for manufacturing a secondary battery includes: forming a processed portion in at least one corner region of a body having a flat plate shape; forming a receiving space to accommodate an electrode assembly in the body; inserting the electrode assembly into the receiving space through an opening of the body; and coupling the body with a cover to seal the receiving space.

In an embodiment, the body may include a flange portion that extends from an end having the opening of the body and is coupled with the cover, the flange portion including the processed portion formed in the at least one corner region.

In an embodiment, the processed portion may be disposed in the at least one corner region of the flange portion, and may be formed to be recessed inward toward the opening.

In an embodiment, the processed portion may be formed to be recessed inward toward the opening by a value greater than or equal to 50% and less than or equal to 95% of a width of the flange portion.

In an embodiment, the processed portion may be disposed in the at least one corner region of the flange portion, and may be formed as a through-hole spaced from the opening by a distance.

In an embodiment, the distance by which one end of the through-hole of the processed portion is spaced from the opening may be 0.2 mm to 0.3 mm.

However, the present disclosure is not limited to the above aspects and features, and the above and additional aspects and features will be set forth, in part, in the detailed description that follows with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings.

FIG. 1 is an exploded perspective view illustrating an example of a secondary battery according to an embodiment of the present disclosure.

FIG. 2 is a perspective view illustrating an example of a secondary battery according to an embodiment of the present disclosure.

FIG. 3 is an exploded perspective view illustrating an example of a case for a secondary battery according to a comparative example.

FIG. 4 is a cross-sectional view illustrating an example of a portion of a case for a secondary battery according to a comparative example.

FIG. 5 is a perspective view illustrating an example in which a recessed shape of a processed portion is formed in an arc shape according to an embodiment of the present disclosure.

FIG. 6 is a perspective view illustrating an example in which a recessed shape of a processed portion is formed in a rectangular shape according to an embodiment of the present disclosure.

FIG. 7 is a perspective view illustrating an example in which a recessed shape of a processed portion is formed in a triangular shape according to an embodiment of the present disclosure.

FIG. 8 is a plan view of a body in which a processed portion is formed according to an embodiment of the present disclosure.

FIG. 9 is a perspective view illustrating an example in which a through-hole shape of a processed portion is formed in a circular shape according to an embodiment of the present disclosure.

FIG. 10 is a perspective view illustrating an example in which a through-hole shape of a processed portion is formed in a rectangular shape according to an embodiment of the present disclosure.

FIG. 11 is a perspective view illustrating an example in which a through-hole shape of a processed portion is formed in a triangular shape according to an embodiment of the present disclosure.

FIG. 12 is a plan view of a body in which a processed portion is formed according to an embodiment of the present disclosure.

FIG. 13 is a flowchart illustrating an example of a method for manufacturing a secondary battery according to an embodiment of the present disclosure.

FIG. 14 is a plan view of a body having a flat plate shape that is prepared in a method for manufacturing a secondary battery according to an embodiment of the present disclosure.

FIG. 15 is a plan view of a body after an operation of forming a processed portion is completed in a method for manufacturing a secondary battery according to an embodiment of the present disclosure.

FIG. 16 is a perspective view illustrating an example of an operation of forming a body in a method for manufacturing a secondary battery according to an embodiment of the present disclosure.

FIG. 17 is a cross-sectional view of a portion of a body after an operation of forming the body is completed in a method for manufacturing a secondary battery according to an embodiment of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

Further, as would be understood by a person having ordinary skill in the art, in view of the present disclosure in its entirety, each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner, unless otherwise stated or implied.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

Further, it should be expected that the shapes shown in the figures may vary in practice depending, for example, on tolerances and/or manufacturing techniques. Accordingly, the embodiments of the present disclosure should not be construed as being limited to the specific shapes shown in the figures, and should be construed considering changes in shapes that may occur, for example, as a result of manufacturing. As such, the shapes shown in the drawings may not depict the actual shapes of areas of the device, and the present disclosure is not limited thereto.

Any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, and the like as being “the same” as each other may mean that they are “substantially the same” as each other. Thus, the phrase “substantially the same” may include a case having a variation or a deviation that is considered low in the art, for example, such as a variation or a deviation of 5% or less. In addition, when a certain parameter is referred to as being uniform in a given region, it may mean that it is uniform in terms of an average.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

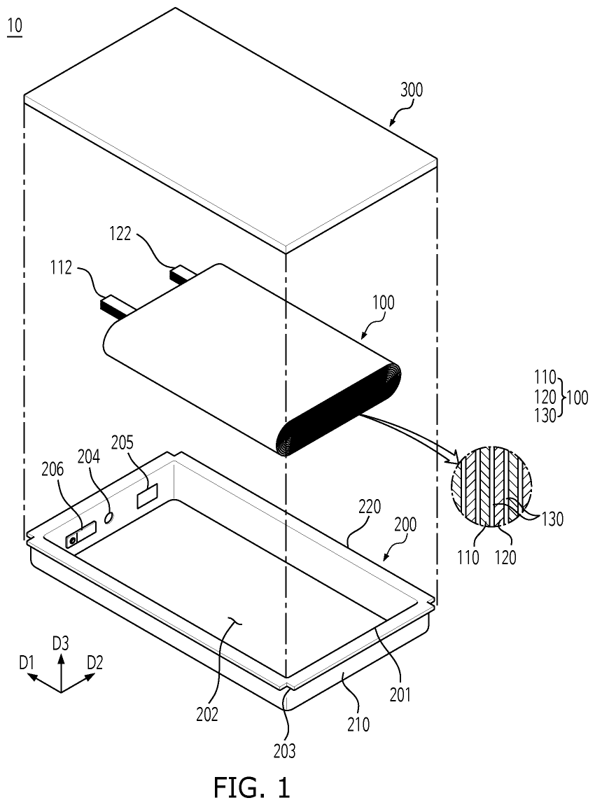

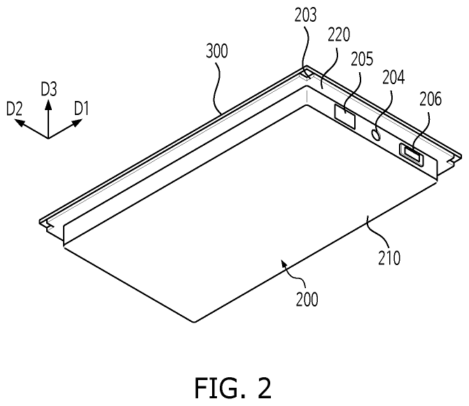

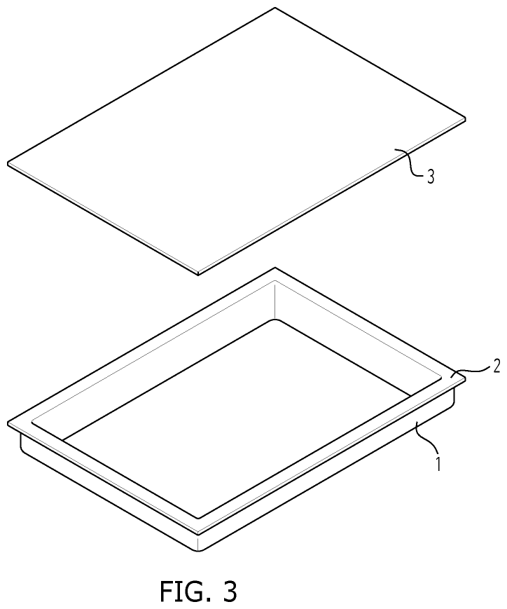

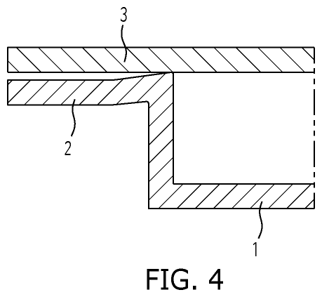

FIG. 1 is an exploded perspective view illustrating an example of a secondary battery according to an embodiment of the present disclosure. FIG. 2 is a perspective view illustrating an example of a secondary battery according to an embodiment of the present disclosure. FIG. 3 is an exploded perspective view illustrating an example of a case for a secondary battery according to a comparative example. FIG. 4 is a cross-sectional view illustrating an example of a portion of a case for a secondary battery according to a comparative example.

Referring to FIG. 1 and FIG. 2, a secondary battery 10 may include an electrode assembly 100, a body 200 having a receiving space 202 for accommodating the electrode assembly 100, and a cover 300 coupled to the body 200. The electrode assembly 100 may include a first electrode 110, a separator 130, and a second electrode 120. For example, the electrode assembly 100 may be wound or stacked with the separator 130, which is an insulator, interposed between the first electrode 110 and the second electrode 120.

The electrode assembly 100 may include the first electrode 110, the separator 130, and the second electrode 120. For example, the electrode assembly 100 may be wound or stacked with the separator 130, which is an insulator, interposed between the first electrode 110 and the second electrode 120. The first electrode 110 may include a first base material, and a first active material layer located on the first base material. A first electrode tab 112 may extend outward from a first uncoated portion of the first base material where the first active material layer is not located. The second electrode 120 may include a second base material, and a second active material layer located on the second base material. A second electrode tab 122 may extend outward from a second uncoated portion of the second base material where the second active material layer is not located.

The first electrode 110 may function as a positive electrode. In this case, the first base material may be a positive electrode base material. The positive electrode base material may be composed of an aluminum foil, and a positive electrode active material may include, for example, a transition metal oxide.

The positive electrode active material may include a compound (e.g., lithiated intercalation compound) that is capable of intercalating and deintercalating lithium. In more detail, at least one of a composite oxide of lithium or a metal selected from cobalt, manganese, nickel, and/or combinations thereof may be used.

The composite oxide may be a lithium transition metal composite oxide. Some examples of the composite oxide may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, the following compounds represented by any one of the following Chemical Formulas may be used. LiaA1-bXbO2-cDc (0.90≤a≤1.8, 0≤b≤0.5, and 0≤c≤0.05); LiaMn2-bXbO4-cDc (0.90≤a≤1.8, 0≤b≤0.5, and 0≤c≤0.05); LiaNi1-b-cCobXcO2-αDα (0.90≤a≤1.8, 0≤b≤0.5, 0≤c≤0.5, and 0<α<2); LiaNi1-b-cMnbXcO2-αDα (0.90≤a≤1.8, 0≤b≤0.5, 0≤c≤0.5, and 0<α<2); LiaNibCocL1dGeO 2(0.90≤a≤1.8, 0≤b≤0.9, 0≤c≤0.5, 0≤d≤0.5, and 0≤e≤0.1); LiaNiGbO2(0.90≤a≤1.8 and 0.001≤b≤0.1); LiaCoGbO2(0.90≤a≤1.8 and 0.001≤b≤0.1); LiaMn1-bGbO2 (0.90≤a≤1.8 and 0.001≤b≤0.1); LiaMn2GbO 4(0.90≤a≤1.8 and 0.001≤b≤0.1); LiaMn1-gGgPO4 (0.90≤a≤1.8 and 0≤g≤0.5); Li(3-f)Fe2(PO4)3 (0≤f≤2); or LiaFePO4(0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing a high capacity, and may be applied to a high-capacity, high-density rechargeable lithium battery.

The second electrode 120 may function as a negative electrode. In this case, the second base material may be a negative electrode base material. The negative electrode base material may be composed of, for example, a copper foil or a nickel foil, and a negative electrode active material may include, for example, graphite.

The negative electrode active material may include a suitable material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon, or a combination thereof. The crystalline carbon may be graphite, such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and/or Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si-Q alloy (where Q is selected from an alkali metal, an alkaline-earth metal, a Group 13 element, a Group 14 element (excluding Si), a Group 15 element, a Group 16 element, a transition metal, a rare earth element, and/or a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon, and silicon particles and an amorphous carbon coating layer on a surface of the core.

The Si-based negative electrode active material or the Sn-based negative electrode active material may be used in combination with a carbon-based negative electrode active material.

The separator 130 may include polyethylene, polypropylene, polyvinylidene fluoride, or a multilayered film of two or more layers thereof, and a mixed multilayered film, such as a polyethylene/polypropylene two-layered separator, a polyethylene/polypropylene/polyethylene three-layered separator, a polypropylene/polyethylene/polypropylene three-layered separator, and/or the like.

The separator may include a porous substrate, and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al2O3, SiO2, TiO2, SnO2, CeO2, MgO, NiO, CaO, GaO, ZnO, ZrO2, Y2O3,SrTiO3, BaTiO3, Mg(OH)2, boehmite, and a combination thereof, but is not limited thereto.

The organic material and the inorganic material may be mixed in one coating layer, or a coating layer including an organic material and a coating layer including an inorganic material may be stacked.

An opening 201 may be formed at one end of the body 200 (e.g., one end of the body 200 in a D3 direction). The body 200 may accommodate the electrode assembly 100 with the one end where the opening 201 is formed being open. The body 200 may have one open end, and the receiving space 202 for accommodating the electrode assembly 100 may be formed.

In a substantially central region of the body 200, the receiving space 202 in which the electrode assembly 100 is accommodated may be formed by, for example, press processing, drawing processing, or the like. For example, a flange portion 220 may be formed in four directions on an upper edge of the receiving space 202. The electrode assembly 100 may be inserted through the opening 201 of the body 200, and may be accommodated in the receiving space 202. The cover 300 may be coupled to the end having the opening 201 of the body 200 to seal the receiving space 202.

In an embodiment, the body 200 may include a processed portion 203 formed in at least one of the corner regions of a surface that is coupled with the cover 300. The body 200 may include the flange portion 220 that extends from the opening 201 of the body 200, is coupled with the cover 300, and has the processed portion 203 formed in at least one corner region thereof. For example, the body 200 may be formed to include a base portion 210 in which the electrode assembly 100 is accommodated, and the flange portion 220 extending from an upper edge of the base portion 210.

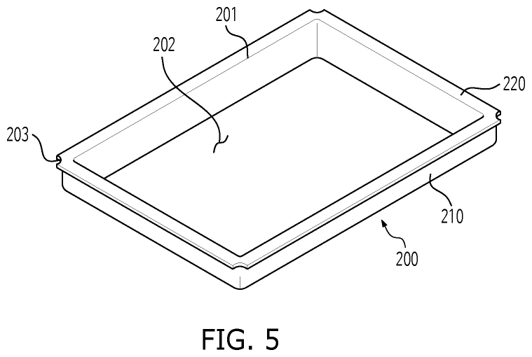

The processed portion 203 may be disposed in at least one corner region of the flange portion 220. For example, the processed portion 203 may be disposed in each of the four corner regions of the flange portion 220. The processed portion 203 may be one in which at least one corner region of the flange portion 220 is chamfered in a suitable shape (e.g., a specific or predetermined shape). In an embodiment, the processed portion 203 may be formed to be recessed inward toward the opening 201. In another embodiment, the processed portion 203 may be formed to be a through-hole, which is spaced apart from the opening 201 by a suitable distance (e.g., a predetermined distance). Various forms and embodiments of the processed portion 203 will be described in more detail below with reference to FIG. 5 to FIG. 8 and FIG. 9 to FIG. 12.

Referring to FIG. 3 and FIG. 4, a case for a secondary battery according to a comparative example may be formed without a separate processing in a corner region of a flange portion 2 of a body 1 that is coupled with a cover 3. In this case, while a press/drawing process for forming the body 1 is performed, a stress may be concentrated on the flange portion 2 in the corner region of the body 1, and the flange portion 2 in the corner region of the body 1 may rise or become thicker.

For example, as illustrated in FIG. 4, when the cover 3 is coupled to the body 1 in a state in which the flange portion 2 in the corner region of the body 1 is raised, welding defects may occur.

In comparison, referring to FIG. 1 and FIG. 2, according to an embodiment of the present disclosure, the body 200 may include the processed portion 203 formed in the corner region of the one surface coupled with the cover 300, and thus, a thickness deviation that may occur during the process of forming the flange portion 220 may be prevented or substantially prevented. As such, a flatness of the flange portion 220 may be secured to prevent or substantially prevent welding defects that may occur when coupling the body 200 and the cover 300 to each other.

In an embodiment, a negative electrode terminal 205 and a positive electrode terminal 206 may be disposed on a side surface (e.g., one surface of the body 200 in a D1 direction) different from the one open surface of the body 200. In some embodiments, the body 200 may also include an electrolyte injection port 204. For example, the electrolyte injection port 204 may be a through-hole formed on a side surface of the body 200. The electrolyte injection port 204 may be formed to allow an electrolyte to be injected into the body 200 of the secondary battery 10 after the body 200 and the cover 300 are joined and sealed together.

The electrolyte injection port 204 may be sealed with a sealing member after the electrolyte is injected. Although the electrolyte injection port 204 is illustrated as being located between a pair of electrode terminals, the present disclosure is not limited thereto, and various modifications may be made. In an embodiment, a pair of electrode terminals may be disposed on a side surface of the body 200. For example, the negative electrode terminal 205 and the positive electrode terminal 206 may be disposed on opposite sides of the electrolyte injection port 204 in a D2 direction.

The positive electrode terminal 206 may be electrically connected to the first electrode tab 112 of the electrode assembly 100, and the negative electrode terminal 205 may be electrically connected to the second electrode tab 122 of the electrode assembly 100. The positions of the positive electrode terminal 206 and the negative electrode terminal 205 are not limited to the positions illustrated in FIG. 1, and various modifications may be made.

The cover 300 may be coupled to the one open surface of the body 200. For example, the cover 300 may be coupled to the end of the body 200 having the opening 201, and may seal the receiving space 202. The body 200 and the cover 300 may be joined together to form an exterior of the secondary battery 10. For example, the cover 300 may be configured as a flat or substantially flat plate disposed on an upper portion of the body 200 to seal the receiving space 202 of the body 200. The cover 300 may be formed as a flat or substantially flat plate having a size sufficient to cover the flange portion 220, so that the cover 300 may be in surface contact with the flange portion 220.

For example, the body 200 and the cover 300 may be metal-bonded (e.g., welded, brazed, soldered, and or the like) to each other. In this case, the flange portion 220 of the body 200 and an edge of the cover 300 may be bonded to each other. For example, after the body 200 and the cover 300 are bonded to each other, at least a portion of the flange portion 220 may be cut using a laser to improve an energy density of the secondary battery 10. For example, a thickness of the body 200 and the cover 300 may be 0.05 mm to 0.3 mm, but the present disclosure is not limited thereto.

In an embodiment, at least one of the body 200 and/or the cover 300 may include stainless steel (SUS). For example, both the body 200 and the cover 300 illustrated in FIG. 1 may include stainless steel (SUS), and the secondary battery 10 may be a SUS can kind of secondary battery, but the present disclosure is not limited thereto. For example, the body 200 and the cover 300 may be formed of a conductive metal, such as aluminum, an aluminum alloy, or a nickel-plated steel, to form the overall appearance of the secondary battery 10.

The body 200 and the cover 300 may also be composed of the same metallic material as each other. When the body 200 and the cover 300 include the same material as each other, a corrosion at a portion where the body 200 and the cover 300 are coupled to each other that may be caused due to a potential difference between different metals may be prevented or substantially prevented. In an embodiment, the metallic material constituting the body 200 and the cover 300 may include stainless steel (SUS). The stainless steel material may be any suitable kind of stainless steel series material, such as SUS 304, SUS 316, SUS 420, SUS 430, and/or the like, depending on the kind and ratio of alloy materials within the stainless steel series.

The secondary battery 10 may be a lithium battery cell, a sodium battery cell, or the like. However, the present disclosure is not limited thereto, and the secondary battery 10 may include any suitable kind of battery that may repeatedly provide electricity through charging and discharging. In an embodiment, when the secondary battery 10 is a lithium secondary battery, the secondary battery 10 may be used in an electric vehicle (EV) because of its excellent life characteristics and high-rate characteristics. For example, the secondary battery 10 may be used in a hybrid vehicle, such as a plug-in hybrid electric vehicle (PHEV). For example, the lithium secondary battery may be used in various suitable fields that require or desire power storage in various ranges. For example, the lithium secondary battery may be used in a smartphone, a tablet PC, an electric bicycle, a power tool, or the like.

The secondary battery Illustrated in FIG. 1 is provided as an example, and in some embodiments, other configurations or elements may be additionally included in addition to those illustrated, and some configurations or elements may be omitted as needed or desired. For example, the shapes, the positional relationships, and the like of each component of the secondary battery illustrated in FIG. 1 may be appropriately modified as needed or desired.

The directions D1, D2, and D3 illustrated in FIG. 1 may indicate a length direction, a width direction, and a thickness direction of the secondary battery 10 or a component of the secondary battery 10 (e.g., the body 200, the electrode assembly 100, and the like), respectively.

In an embodiment, the body 200 may be bonded to the cover 300 by laser welding. However, the present disclosure is not limited thereto, and the bonding method is not particularly limited, such that various suitable bonding methods capable of sealing the body 200 may be used.

For example, the body 200 and the cover 300 may be metal-bonded (e.g., welded, brazed, soldered, and/or the like) to each other. As another example, the body 200 and the cover 300 may be bonded to each other through a separate adhesive layer. The adhesive layer may include at least one of a hot melt, a rubber, or an acrylic. For example, when the adhesive layer includes a hot-melt adhesive, the hot-melt adhesive may include an acrylic resin, a synthetic rubber-based resin, a polyolefin-based resin, an ester-based resin, a urethane-based resin, an epoxy-based resin, or a silicone-based resin, but the present disclosure is not limited thereto. For example, the hot-melt adhesive may be impregnated into a film by applying a melted hot-melt adhesive solution to a film layer, or by impregnating the film layer with a hot-melt adhesive solution dissolved in a solvent and then volatilizing the solvent, but the present disclosure is not limited thereto, and various suitable impregnation methods of the hot-melt adhesive may be used.

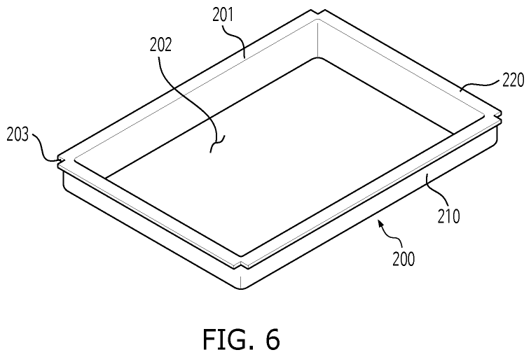

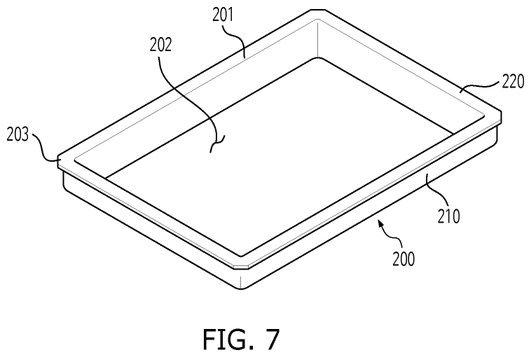

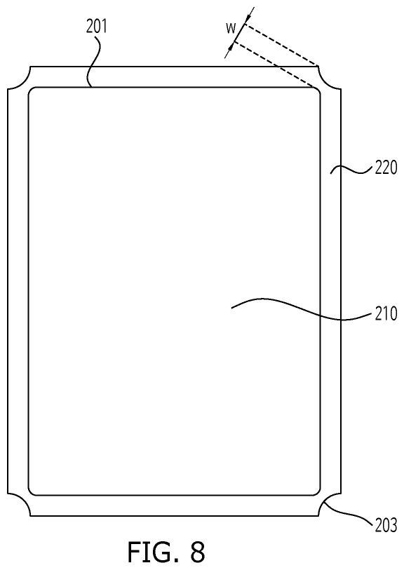

FIG. 5 is a perspective view illustrating an example in which a recessed shape of a processed portion is formed in an arc shape according to an embodiment of the present disclosure. FIG. 6 is a perspective view illustrating an example in which a recessed shape of a processed portion is formed in a rectangular shape according to an embodiment of the present disclosure. FIG. 7 is a perspective view illustrating an example in which a recessed shape of a processed portion is formed in a triangular shape according to an embodiment of the present disclosure. FIG. 8 is a plan view of a body in which a processed portion is formed according to an embodiment of the present disclosure.

Referring to FIG. 5 to FIG. 8, a processed portion 203 may be formed by chamfering at least one corner region of a flange portion 220. The processed portion 203 may be disposed in at least one corner region of the flange portion 220, and may be formed to be recessed inward toward an opening 201. In an embodiment, the processed portion 203 may be disposed in each of the four corner regions of the flange portion 220, and may each be formed to be recessed inward toward the opening 201.

The processed portion 203 may be formed through a trimming process. For example, the processed portion 203 may be formed so that a shape of the processed portion 203 that is recessed inward toward the opening 201 may be any one of a triangle, a rectangle, or an arc. However, the present disclosure is not limited thereto, and a recessed shape of the processed portion 203 may be variously implemented as an ellipse, other suitable shapes, or the like as necessary or desired.

In an embodiment, a body 200 may be formed to include a base portion 210 and the flange portion 220 in a drawing forming process, and the base portion 210 may form a receiving space 202 for accommodating an electrode assembly. In the drawing forming process of the body 200, it may be possible to prevent or substantially prevent a stress from being concentrated in a corner region through the processed portion 203 formed to be recessed in the corner region of the flange portion 220.

For example, when forming the body 200, a stress may be concentrated in a corner region of the flange portion 220 relative to a straight region of the flange portion 220, and if there is no space for a material of the corner region to be pushed out, the corner region of the flange portion 220 may become thicker. The processed portion 203 may be disposed in at least one corner region of the flange portion 220 and recessed inward toward the opening 201, and thus, may provide a space for the material of the corner region of the flange portion 220 to be pushed out when forming the body 200. Accordingly, in the drawing forming process of the body 200, it may be possible to prevent or substantially prevent a stress from being concentrated in the corner region of the flange portion 220, and to secure a flatness of the flange portion 220.

In an embodiment, the processed portion 203 may be formed to be recessed inward toward the opening 201 by greater than or equal to 50% and less than or equal to 95% of a width W of the flange portion 220. The body 200 is coupled with a cover after the drawing forming is completed, and thus, it may be desirable to secure a section to be welded with the cover.

For example, after the body 200 is coupled with the cover, the body 200 may be welded along a line that is spaced apart from the opening 201 by a suitable distance (e.g., a certain or predetermined distance). In this case, if the processed portion 203 is formed to be recessed inward by less than 50% of the width W of the flange portion 220, an effect of reducing a corner stress due to the processed portion 203 may be reduced. For example, if the processed portion 203 is formed to be recessed inward by exceeding 95% of the width W of the flange portion 220, it may be difficult to secure a welding area of a portion adjacent to the processed portion 203.

Therefore, the processed portion 203 may be formed to be recessed inward toward the opening 201 by greater than or equal to 50% and less than or equal to 95% of the width W of the flange portion 220, so that a welding area of the body 200 and the cover may be secured, while improving a flatness of the flange portion 220 when forming the body 200. As such, it may be possible to maintain a rigidity of the case for a secondary battery, while preventing or substantially preventing welding defects.

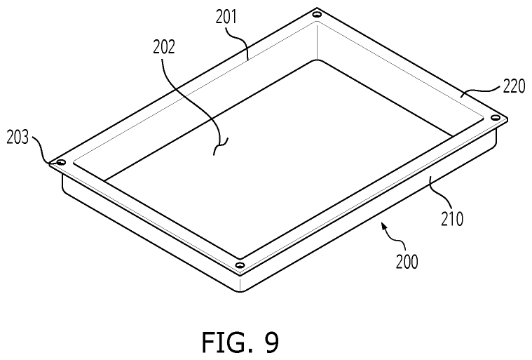

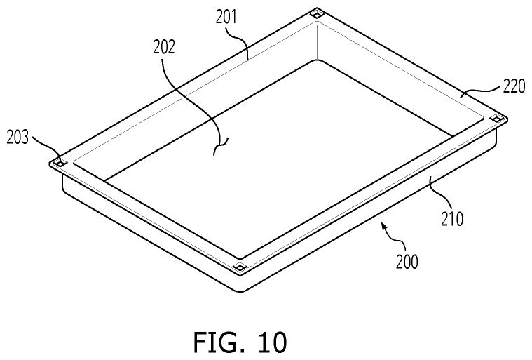

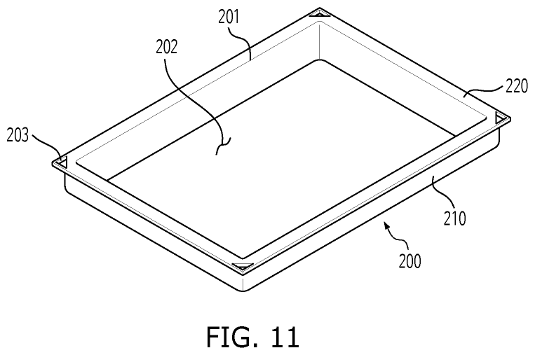

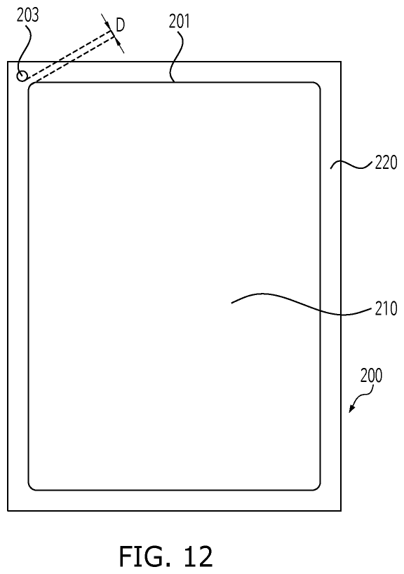

FIG. 9 is a perspective view illustrating an example in which a through-hole shape of a processed portion is formed in a circular shape according to an embodiment of the present disclosure. FIG. 10 is a perspective view illustrating an example in which a through-hole shape of a processed portion is formed in a rectangular shape according to an embodiment of the present disclosure. FIG. 11 is a perspective view illustrating an example in which a through-hole shape of a processed portion is formed in a triangular shape according to an embodiment of the present disclosure. FIG. 12 is a plan view of a body in which a processed portion is formed according to an embodiment of the present disclosure.

Referring to FIG. 9 to FIG. 12, a processed portion 203 may be disposed in at least one corner region of a flange portion 220, and may be formed as a through-hole spaced apart from an opening 201 by a suitable distance (e.g., a predetermined distance). In an embodiment, the processed portion 203 may be disposed in each of the four corner regions of the flange portion 220, and may be formed as a through-hole spaced apart from the opening 201 by a suitable distance (e.g., a predetermined distance).

The processed portion 203 may be formed through a punching process. For example, the processed portion 203 may be formed to have any one of a triangle shape, a rectangle shape, or a circle shape in a plan view. However, the present disclosure is not limited thereto, and a through-hole shape of the processed portion 203 may be variously modified as an ellipse, other suitable shapes, or the like as necessary or desired.

In an embodiment, a body 200 may be formed to include a base portion 210 and the flange portion 220 in a drawing forming process, and the base portion 210 may form a receiving space 202 for accommodating an electrode assembly. In the drawing forming process of the body 200, it may be possible to prevent or substantially prevent a stress from being concentrated in a corner region through the processed portion 203 formed to penetrate the corner region of the flange portion 220.

For example, when forming the body 200, a stress may be concentrated in a corner region of the flange portion 220 relative to a straight region of the flange portion 220, and if there is no space for a material of the corner region to be pushed out, the corner region of the flange portion 220 may become thicker. The processed portion 203 may be disposed in at least one corner region of the flange portion 220 as a through-hole spaced apart from the opening 201 by a suitable distance (e.g., a predetermined distance), and thus, may provide a space for the material of the corner region of the flange portion 220 to be pushed out when forming the body 200. Accordingly, in the drawing forming process of the body 200, it may be possible to prevent or substantially prevent a stress from being concentrated in the corner region of the flange portion 220, and to secure a flatness of the flange portion 220.

In an embodiment, a distance D by which one end of the processed portion 203 is spaced apart from the opening 201 may be 0.2 mm to 0.3 mm. The body 200 may be coupled with a cover after the drawing forming process is completed, and thus, it may be desirable to secure a section to be welded with the cover.

For example, after the body 200 is coupled with the cover, the body 200 may be welded along a line that is spaced apart from the opening 201 by a suitable distance (e.g., a certain or predetermined distance). In this case, if the distance D by which one end of the processed portion 203 is spaced apart from the opening 201 is less than 0.2 mm, it may be difficult to secure a welding area of a portion adjacent to the processed portion 203. For example, if the distance D by which one end of the processed portion 203 is spaced apart from the opening 201 exceeds 0.3 mm, an effect of reducing a corner stress due to the processed portion 203 may be reduced.

The distance D by which one end of the processed portion 203 is spaced apart from the opening 201 may be formed to be 0.2 mm to 0.3 mm, so that a welding area of the body 200 and the cover may be secured, while improving the flatness of the flange portion 220 when forming the body 200. As such, it may be possible to maintain a rigidity of the case for a secondary battery, while preventing or substantially preventing welding defects.

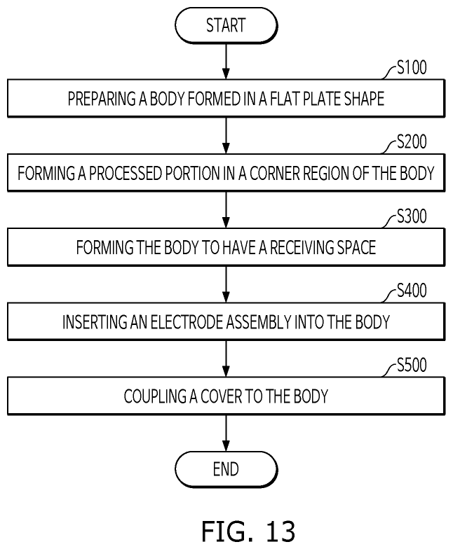

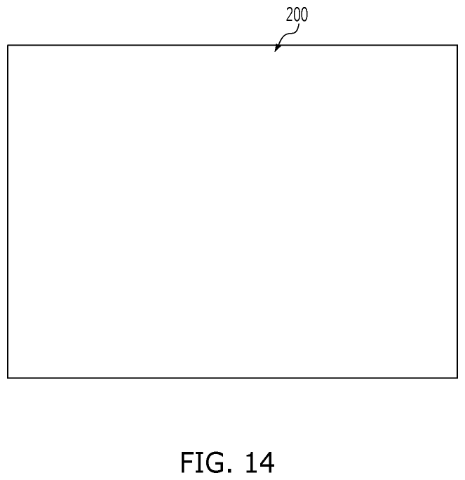

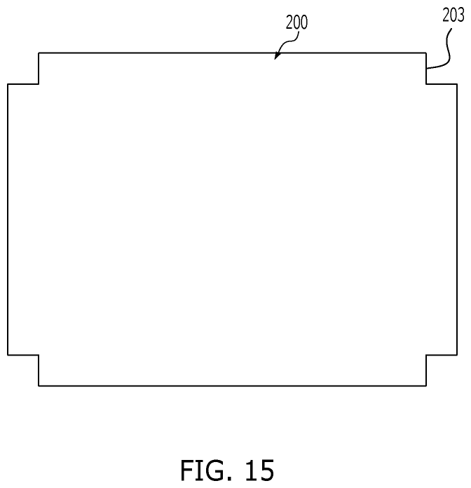

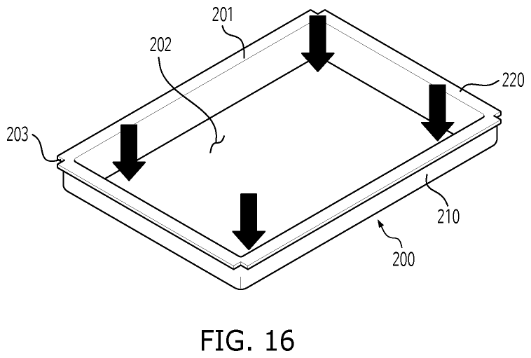

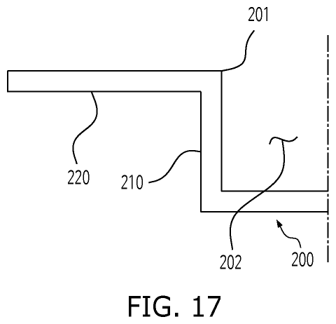

FIG. 13 is a flowchart illustrating an example of a method for manufacturing a secondary battery according to an embodiment of the present disclosure. FIG. 14 is a plan view of a body having a flat plate shape that is prepared in a method for manufacturing a secondary battery according to an embodiment of the present disclosure. FIG. 15 is a plan view of a body after an operation of forming a processed portion is completed in a method for manufacturing a secondary battery according to an embodiment of the present disclosure. FIG. 16 is a perspective view illustrating an example of an operation of forming a body in a method for manufacturing a secondary battery according to an embodiment of the present disclosure. FIG. 17 is a cross-sectional view of a portion of a body after an operation of forming the body is completed in a method for manufacturing a secondary battery according to an embodiment of the present disclosure.

In an embodiment, referring to FIG. 13, a method for manufacturing a secondary battery may start, and a body formed in a flat plate shape may be prepared (S100). A processed portion in a corner region of the body may be formed (S200). The body may be formed to have a receiving space (S300), and an electrode assembly may be inserted into the body (S400). A cover may be coupled to the body (S500), and the method may end.

The operation of preparing the body (S100) may be an operation of preparing the body 200 formed in a flat plate shape as illustrated in FIG. 14. The operation of forming the processed portion (S200) may be an operation of forming the processed portion 203 in at least one corner region of the body 200 as illustrated in FIG. 15.

After the operation of forming the processed portion (S200) is performed, the operation of forming the body (S300) may be performed. The operation of forming the body (S300) may be an operation of forming the body 200 so that a receiving space 202 for accommodating an electrode assembly is formed as illustrated in FIG. 16. In the operation of forming the body (S300), the body 200 may be formed to include a flange portion 220 that extends from an end having an opening 201 of the body 200. The flange portion 220 may be coupled with a cover, and may have the processed portion 203 formed in at least one corner region.

For example, in the operation of forming the body (S300), a base portion 210 and a receiving space 202 may be formed in the body 200 by press processing, drawing processing, or the like. For example, the flange portion 220 may be formed in four directions on an upper edge of the receiving space 202. An electrode assembly may be inserted through the opening 201 of the body 200, and may be accommodated in the receiving space 202.

The processed portion 203 may be disposed in at least one corner region of the flange portion 220, and may be formed to be recessed inward toward the opening 201. In this case, the processed portion 203 may be formed to be recessed inward toward the opening 201 by greater than or equal to 50% and less than or equal to 95% of a width of the flange portion 220. In another embodiment, the processed portion 203 may be disposed in at least one corner region of the flange portion 220, and may be formed to be a through-hole spaced apart from the opening 201 by a suitable distance (e.g., a predetermined distance). In this case, a distance by which one end of the processed portion 203 is spaced apart from the opening 201 may be 0.2 mm to 0.3 mm.

After the operation of forming the body (S300), an operation of inserting the electrode assembly into the body (S400) may be performed. The operation of inserting the electrode assembly (S400) may be an operation of inserting the electrode assembly into the receiving space through the opening of the body. After the operation of inserting the electrode assembly (S400), an operation of coupling the cover to the body (S500) may be performed.

The operation of coupling the cover to the body (S500) may be an operation of coupling the body with the cover to seal the receiving space. According to an embodiment of the present disclosure, by performing the operation of forming the processed portion S200 before the operation of forming the body S300, the flange portion 220 may secure a flatness as illustrated in FIG. 17. When the cover is coupled to the body in this state, a quality of the secondary battery may be secured by preventing or substantially preventing welding defects and the like.

The flowchart of FIG. 13 described above is provided as an example, and the present disclosure is not limited to the flowchart of FIG. 13 described above. For example, one or more operations in the flowchart described above may be added/changed/deleted, an order of one or more operations may be changed, and/or one or more operations may be performed concurrently (e.g., simultaneously or substantially simultaneously) with each other.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

### DESCRIPTION OF SOME REFERENCE SYMBOLS

10: secondary battery
100: electrode assembly
200: body
201: opening
202: receiving space
203: processed portion
210: base portion
220: flange portion
300: cover

What is claimed is:

1. A case for a secondary battery, comprising:
a body having an opening at one end, and comprising a receiving space configured to accommodate an electrode assembly; and
a cover configured to be coupled to the one end having the opening to seal the receiving space,
wherein the body further comprises a processed portion in at least one corner region of a surface of the body to be coupled with the cover.

2. The case for a secondary battery as claimed in claim 1, wherein the body comprises a flange portion extending from the one end having the opening of the body to be coupled with the cover, the flange portion comprising the processed portion in the at least one corner region.

3. The case for a secondary battery as claimed in claim 2, wherein the processed portion in the at least one corner region of the flange portion is recessed inward toward the opening.

4. The case for a secondary battery as claimed in claim 3, wherein the processed portion is recessed inward toward the opening in a shape of one of a triangle, a rectangle, or an arc.

5. The case for a secondary battery as claimed in claim 3, wherein the processed portion is recessed inward toward the opening by a value greater than or equal to 50% and less than or equal to 95% of a width of the flange portion.

6. The case for a secondary battery as claimed in claim 2, wherein the processed portion in the at least one corner region of the flange portion is a through-hole spaced from the opening by a distance.

7. The case for a secondary battery as claimed in claim 6, wherein, in a plan view, the through-hole of the processed portion has a shape of one of a triangle, a rectangle, or a circle.

8. The case for a secondary battery as claimed in claim 6, wherein the distance by which one end of the through-hole of the processed portion is spaced from the opening is 0.2 mm to 0.3 mm.

9. The case for a secondary battery as claimed in claim 1, wherein the body and the cover comprise a same metallic material as each other.

10. The case for a secondary battery as claimed in claim 9, wherein the metallic material comprises stainless use steel.

11. A secondary battery comprising:
an electrode assembly comprising a first electrode, a separator, and a second electrode;
a body having an opening at one end, and comprising a receiving space accommodating the electrode assembly; and
a cover coupled to the one end having the opening, and sealing the receiving space,
wherein the body comprises a processed portion in at least one corner region of a surface coupled with the cover.

12. The secondary battery as claimed in claim 11, wherein the body comprises a flange portion extending from the one end having the opening of the body and coupled with the cover, the flange portion comprising the processed portion in the at least one corner region.

13. The secondary battery as claimed in claim 12, wherein the processed portion in the at least one corner region of the flange portion is recessed inward toward the opening.

14. The secondary battery as claimed in claim 12, wherein the processed portion in the at least one corner region of the flange portion is a through-hole spaced from the opening by a distance.

15. A method for manufacturing a secondary battery, comprising:
forming a processed portion in at least one corner region of a body having a flat plate shape;
forming a receiving space to accommodate an electrode assembly in the body;
inserting the electrode assembly into the receiving space through an opening of the body; and
coupling the body with a cover to seal the receiving space.

16. The method for manufacturing a secondary battery as claimed in claim 15, wherein the body comprises a flange portion that extends from an end having the opening of the body and is coupled with the cover, the flange portion comprising the processed portion formed in the at least one corner region.

17. The method for manufacturing a secondary battery as claimed in claim 16, wherein the processed portion is disposed in the at least one corner region of the flange portion, and is formed to be recessed inward toward the opening.

18. The method for manufacturing a secondary battery as claimed in claim 17, wherein the processed portion is formed to be recessed inward toward the opening by a value greater than or equal to 50% and less than or equal to 95% of a width of the flange portion.

19. The method for manufacturing a secondary battery as claimed in claim 16, wherein the processed portion is disposed in the at least one corner region of the flange portion, and is formed as a through-hole spaced from the opening by a distance.

20. The method for manufacturing a secondary battery as claimed in claim 19, wherein the distance by which one end of the through-hole of the processed portion is spaced from the opening is 0.2 mm to 0.3 mm.
